(19) United States
(12) Patent Application Publication
(10) Pub. No.: US 2008/0312850 A1
(43) Pub. Date: Dec. 18, 2008

(54) CORRECTION OF IN-LINE INSPECTION RUN DATA LOGS USING ACOUSTICAL DATA

(76) Inventor: Shamus McDONNELL, Edmonton (CA)

Correspondence Address: DAVIS BUJOLD & Daniels, P.L.L.C., 112 PLEASANT STREET, CONCORD, NH, 03301, US

(21) Appl. No.: 12/139,988

(22) Filed: Jun. 16, 2008

Related U.S. Application Data
(60) Provisional application No. 60/943,900, filed on Jun. 14, 2007.

(51) Int. Cl. G01N 29/44

(52) U.S. Cl. 702/56

(57) ABSTRACT

A method of correcting in-line inspection run data logs using acoustical data includes positioning above ground markers periodically along a length of a pipeline to be inspected. The above ground markers generating detection events as an inspection tool passes. Acoustic detectors are positioned periodically along the length of the pipeline. An inspection tool travels along the length of the pipeline. An inspection log is created based on the detection events. Acoustic data generated by the inspection tool is recorded, and used to adjust the inspection log.

### FIELD

The correction of data logs obtained from in-line inspections of pipelines using acoustical data generated by the inspection.

### BACKGROUND

Above Ground Markers (AGM) in the pipeline industry are typically deployed timer boxes to pre-defined reference points along the surface of a pipeline and provide methods to record non-magnetic right of way features on the log for distance correlation. The AGMs are used to measure from when locating anomalies detected by the tool. There are two methods to accomplish this task: make the right of way feature appear on the log, or record the passage of the tool and then look up the odometer distance for that location after the tool traps.

Today's in-line inspection (ILI) tools mostly use a dual clock time based system. This system consists of one clock on the ILI tool, and several remote timer boxes with clocks, each synchronized to the ILI tool and GPS time. The boxes are deployed above the pipe at pre-selected reference sites above the pipeline. The timer boxes must be able to detect the ILI tool in order to record the passage time. The timer boxes will typically use either 22 Hz or magnetic sensors that record the respective fields from the ILI tool.

The timer box records the time that the ILI tool passes under the box, and that time is later used to look up the distance of the ILI tool odometer at the recorded time. This creates a correlation point between the above ground reference site, where the timer box was deployed, and the ILI tool odometer. The correlation point is then used as a starting point to survey to anomalies recorded on the ILI tool.

Typical ILI odometer accuracy is +/−<0.5%, and chaining with conventional methods is usually accurate to +/−<0.1%. This creates a maximum expected error of +/−0.6% on measuring anomalies from the AGM site (although this number is typically around +/−0.2%). Measuring one mile from an AGM can result in a worst case of 31.7′ of error (0.6%×5,280′). This requires that AGMs sites be created every one to two miles along the pipeline, ensuring that the longest measurements are kept to one mile in length, with a worst case error of less than 32′.

Additional problems can include discrepancies between actual AGM deployment and the documented AGM location. This occurs when the information reported by the technicians responsible for the AGM deployment during the inspection run is in conflict with the documented location. Some instances may require the AGM to be relocated due to any number of environmental factors, however if not properly documented the relocation can invalidate the AGM. Similarly, if an AGM fails to detect the passage of the tool, the AGM can no longer be used as a valid AGM reference for the ILI logs.

Corrections to the ILI logs can be made at known reference points along the pipeline also described as Above Ground References (AGR's). AGR's will typically be a pipeline features that is visible above ground but will also show up in the ILI logs. Best examples of an AGR are valves which are pipeline features that are easily picked up by all ILI tools. To do the correction, a timer box is deployed at a known distance upstream or downstream of the AGR. The passage times at the AGM and the AGR plus the known distance between the two are then used to correct the ILI logs. The problem with this is not the corrections themselves, but the interval that they occur as most AGR's like valves can be as much as 50 to 75 km apart.

### SUMMARY

There is provided a method of correcting in-line inspection run data logs using acoustical data. The method comprises positioning above ground markers periodically along a length of a pipeline to be inspected. The above ground markers generating detection events as an inspection tool passes. Acoustic detectors are positioned periodically along the length of the pipeline. An inspection tool travels along the length of the pipeline. An inspection log is created based on the detection events. Acoustic data generated by the inspection tool is recorded, and used to adjust the inspection log.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic of an inspection tool passing through a pipeline.

FIG. 2 is a graphical representation of acoustical data generated by an inspection tool.

FIG. 3 is a chart depicting the use of acoustical data to correct a data log.

### DETAILED DESCRIPTION

By using data logged from acoustic recording devices, such as a geophone, in conjunction with an AGM and its traditional pig detection tools, in-line inspection (ILI) log corrections can be achieved and documented at all AGM's. This would bring the correction intervals of typical AGM deployment at 2 to 5 km rather than each AGR with intervals as high as 50 to 75 km.

The correction process corrects to Below Grade References (BGR). The most common example of a BGR would be pipeline welds.

Most pig runs produce a recognizable acoustic pattern as the pig tool brushes past girth welds and other features inside the pipeline, BGR's. In all cases, the noise generated by the pig can be detected long before any other traditional sensor is capable of detecting the pig passage, in some cases several kms. By logging the noise generated and analyzing the amplitude signals and patterns, several pieces of information can be determined and used for In-Line-Inspection log validation and correction.

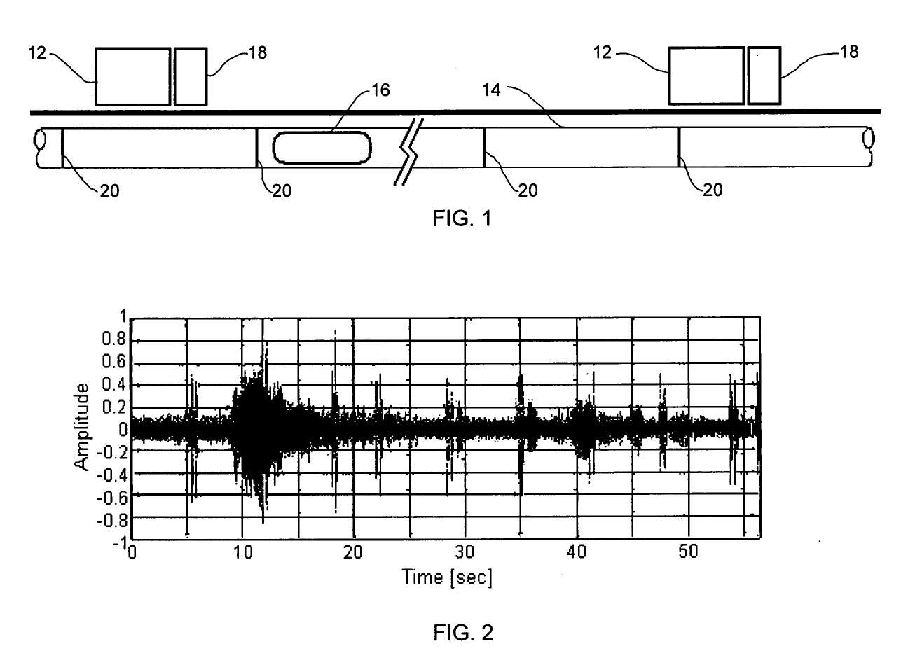

FIG. 2 depicts a typical pig passage amplitude pattern generated by a pig moving down the pipeline and demonstrates several important pieces of information, such as BGR detection, pig speed, distance between BGRs, and pig passage time.

BGR detection—As the pig is propelled through the pipe it comes in contact with girth welds and produces vibration or noise in the pipe which is conducted down the length of pipeline pipe until fully attenuated. In some cases pigs can be detected contacting girth welds from several km away. Recording This information will essentially create a mapping of the pipeline, complete with joint lengths.

Pig speed—The pig length is always available from the manufacture or before the pig is launched. This information combined with the total time that it takes for the pig to pass over a girth weld in the pipeline, can be used to accurately calculate the pig speed to the time resolution of the recording.

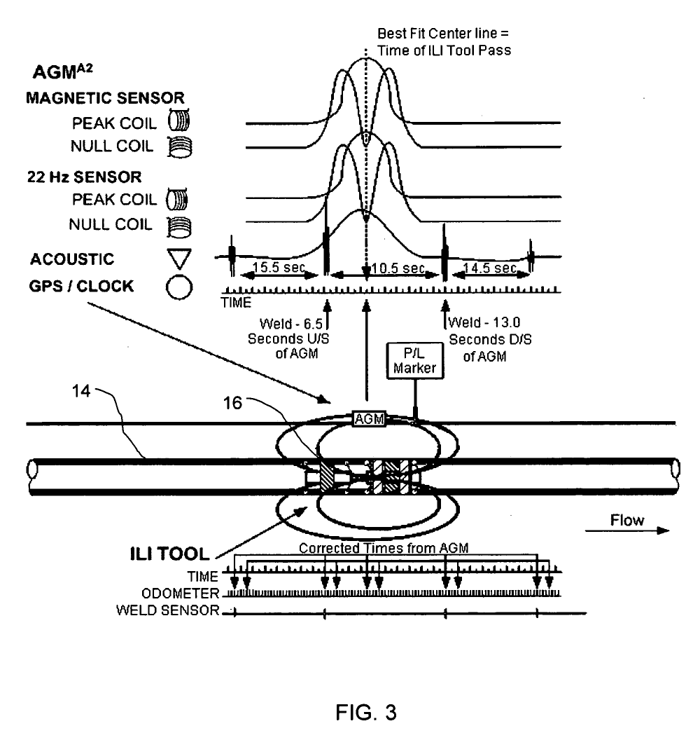

Distance between BGRs—Continuous time based acoustic recordings, as shown in FIG. 3, will demonstrate all girth welds and other BGRs that the pig comes in contact with while being propelled down the pipeline. Once the pig speed is determined, that value can be used in conjunction with the time between BGRs to calculate the distance between BGRs.

Pig passage time—As the pig approaches the AGM the vibrations/noise increases to a point where it climaxes directly beneath the AGM/acoustic recording device.

Once the pipeline joint lengths have been calculated and the pig passage time has been determined, the combined information can be used to correct the ILI logs and accurately validate the position of the AGM to a position on the pipeline.

The pig passage time can be correlated with the ILI time clock to give a relative above ground position of the AGM. Similarly, the acoustic information with the acoustically determined BGR features can be correlated with the ILI time clock to give an exact position of AGM on the pipeline. Additionally, BGR's upstream and downstream of the AGM's position can be used to validate tie position of the AGM by comparing the acoustic joint lengths with the joint lengths recorded by the ILI tool.

Referring to FIG. 1, a method of correcting in-line inspection run data logs using acoustical data will be described. AGMs 12 are positioned periodically along a length of a pipeline 14 that is to be inspected. AGMs generate detection events as an inspection tool 16 passes, which are recorded in a data recorder either in AGM 12, inspection tool 16, or are transmitted to a central server to create an ILI log. Acoustic detectors 18 are also positioned periodically along the length of pipeline 14. While acoustic detectors 18 are shown as being located at the same position as AGMs 12, this need not be the case. The separation between AGMs 12 and acoustic detectors 18 may vary depending on the situation, the equipment being used, and the preferences of the use. Acoustic data that is generated by inspection tool 16 is recorded as it passes along pipeline 14. For example, acoustic vibrations are generated as inspection tool 16 passes over girth welds 20. Once the ILI log and acoustic data are recorded, the acoustic data is analyzed to calculate data such as the speed of the inspection tool, the position of below grade references, distance between below grade references, and inspection tool passage time, and to adjust the inspection log to improve its accuracy.

Several benefits can be realized by implementing acoustic corrections to ILI logs:
Accurate positioning of AGM to pipeline features and ILI logs
Validation of AGM position through upstream and downstream BGR's
Validation of ILI logs to all AGM positions instead of less frequent AGR's
Documented validation of pig passage time, upstream and downstream joints
Increased accuracy for locating of anomalies

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method of correcting in-line inspection run data logs using acoustical data, comprising:
positioning above ground markers periodically along a length of a pipeline to be inspected, the above ground markers generating detection events as an inspection tool passes;
positioning acoustic detectors periodically along the length of the pipeline;
causing an inspection tool to travel along the length of the pipeline;
creating an inspection log based on the detection events;
recording acoustic data generated by the inspection tool;
using the acoustic data to adjust the inspection log.

2. The method of claim 1, further comprising the step of using the acoustic data to calculate at least one of: the speed of the inspection tool, the position of below grade references, distance between below grade references, and inspection tool passage time.

3. The method of claim 1, wherein the above ground markers generate detection events in a data recorder in the above ground marker or in the inspection tool.
